(19) United States
(12) Patent Application Publication
(10) Pub. No.: US 2026/0054279 A1
(43) Pub. Date: Feb. 26, 2026

(54) ELECTROSTATIC SPRAY NOZZLE INCLUDING INDUCTION RING

(71) Applicant: Spraying Systems Co., Wheaton, IL (US)

(72) Inventors: Joseph KREIKEMEIER, Western Springs, IL (US); Collin MALONEY, Naperville, IL (US); Joseph SZCZAP, Naperville, IL (US)

(21) Appl. No.: 18/813,366

(22) Filed: Aug. 23, 2024

(51) Int. Cl. B05B 5/043; B05B 5/053

(52) U.S. Cl. CPC B05B 5/043; B05B 5/053

(57) ABSTRACT

An electrostatic spray nozzle assembly is described that includes an induction ring and a fluid tip. The induction ring generates an electrical field for inducing an electrical charge on droplets of a feedstock liquid from the fluid tip that pass through an opening of the induction ring. The induction ring is electrically coupled to an electrical induction field source via a first conductive path comprising at least an electrically conductive pliable structure, such as a stainless steel spring. Feedstock flowing through the fluid tip is electrically coupled to a charge carrier source via a second conductive path provided by at least a conductive surface of a fluid tube coupled to the fluid tip. The first conductive path and the second conductive path are electrically isolated by an insulating barrier.

### AREA OF THE INVENTION

The present disclosure generally relates to electrostatic sprayer systems. More particularly, the present disclosure relates to an arrangement for providing an electrostatically charged spray using an induction ring in an electrostatic spray drying system.

### BACKGROUND OF THE INVENTION

In known electrostatic sprayer systems, liquid feed stock is charged to an electrical potential of tens of thousands of volts (e.g., 30 kilovolts) and discharged at a spray outlet. The high voltage potential causes the resulting electrically charged spray droplets to repel one another and thereby ensure a wide and uniform dispersal of the spray droplets and thereby facilitate efficient and complete drying of solids, which are suspended in the liquid feed stock, during a spray operation.

In such known electrostatic sprayer systems, during operation thereof, charging of liquid feed stock occurs prior to the feed stock being converted to a spray at a nozzle outlet aperture. Such arrangement results in a high voltage presence that extends from an exit point of the feed stock at the spray nozzle tip to a tank containing the liquid feed stock. As a consequence the entire feedstock tank and the entire path of the feedstock from the tank to an exit aperture of the spray nozzle must be electrically insulated to avoid a short circuit and loss of charge. As such, this approach requires specially configured components along the path of the electrically charged feedstock—including pumps, flow meters, pressure sensors, nozzle aperture actuators, etc.

As an alternative to the above-described electrostatic sprayer arrangement, where the entire feedstock is charged prior to exiting a spray nozzle, electrostatic spray systems exist that include an induction ring positioned proximate an exit aperture of the spray nozzle to induce a charge on spray droplets exiting a spray nozzle. The induction ring, positioned at an exit point of the spray nozzle, is maintained at a high magnitude (either positive or negative) voltage creating a high magnitude electrical field potential that draws (or repels in the instance of a strong negative electric field) electrons from the liquid feedstock exiting the spray nozzle. The attracted (or repelled) electrons result in a negative (or positive) charge being carried by droplets exiting the spray nozzle.

An example of using an induction ring to charge a spray after exiting a nozzle is provided, for example, in U.S. Pat. No. 4,343,433 for “Internal Atomizing Spray Head with Secondary Annulus Suitable for Use with Induction Charging Electrode.”

### SUMMARY OF THE INVENTION

An induction ring-based electrostatic spray nozzle is provided herein for use in an electrostatic sprayer system. The arrangement includes an induction ring and a fluid tip. The induction ring generates an electrical field for inducing an electrical charge on droplets of a feedstock liquid from the fluid tip that pass through an opening of the induction ring. The induction ring is electrically coupled to an electrical induction field source via a first conductive path comprising at least an electrically conductive pliable structure. Feedstock flowing through the fluid tip is electrically coupled to a charge carrier source via a second conductive path provided by at least a conductive surface of a fluid tube coupled to the fluid tip. The first conductive path and the second conductive path are electrically isolated by an insulating barrier.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram of an exemplary electrostatic spray drying system in in accordance with an illustrative example;

FIG. 2A is a first cross-section view of an electrostatic spray nozzle assembly in accordance with an illustrative example;

FIG. 2B is a second cross-section view of an electrostatic spray nozzle assembly in accordance with an illustrative example;

FIG. 3 is a detail cross-section view of nozzle head section, including an induction ring, of the electrostatic spray nozzle assembly depicted in FIGS. 2A and 2B; and

FIG. 4 is an exploded perspective view of the electrostatic spray nozzle assembly depicted in FIGS. 2A and 2B.

### DETAILED DESCRIPTION OF THE INVENTION

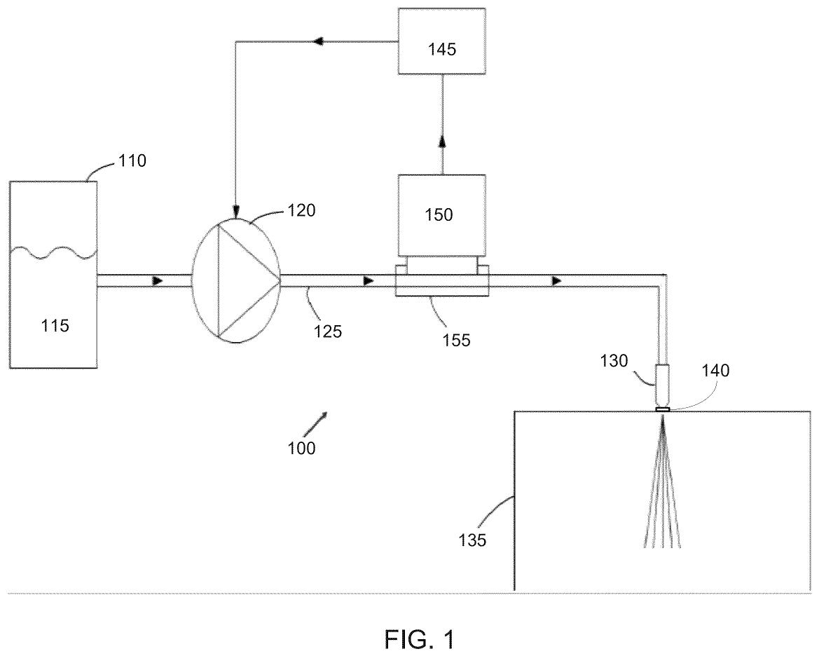

In the present disclosure, an arrangement is provided for providing an electrostatically charged spray nozzle that incorporates an electrical circuit arrangement that ensures proper operation of an electrostatic spray nozzle that includes an induction ring for providing an electrostatic charge to the output spray of the electrostatic spray nozzle. Turning to FIG. 1, an exemplary electrostatic spray drier system 100 is illustratively depicted. In the illustrative example, a tank 110 holds a liquid feed stock 115. The liquid feed stock 115 is drawn by a motor-driven pump 120 from the tank 110 into and through a feed line 125 for discharge at an electrostatic spray nozzle 130 inside a spray drying chamber 135. Importantly, the spray nozzle includes an induction ring 140. The induction ring 140 is positioned at an exit aperture of the electrostatic spray nozzle such that, in operation, the high voltage electric field generated by the induction ring (e.g., 3000 Volts) applies/establishes an electrostatic charge potential to droplets within a spray created from the liquid feed stock 115 discharged from the electrostatic spray nozzle 130.

An aspect of a particular configuration, of the electrostatic spray nozzle 130 including the induction ring 140, adapts/configures the electrostatic spray nozzle 130 for particular use in spray drying of a feedstock. In particular a sufficient voltage differential is applied, between the induction ring 140 and the feedstock at an exit aperture of the nozzle 130, to enhance droplet formation from the feedstock material by an induced charge present in the liquid passing from the exit aperture of the nozzle 130. Such voltage may be 500 to 8,000 volts, which is substantially lower (e.g., an order of magnitude) than known electrostatic spraying systems that operate at, for example, 30,000 volts. Additionally, given variations in conductivity of feedstock, a closed loop control arrangement is contemplated in illustrative examples to facilitate an automatic setting of a voltage difference between the induction ring 140 and the exit aperture of the electrostatic spray nozzle 130 to ensure sufficient voltage is applied to ensure enhanced/desired droplet formation without excessive voltage being applied. Such feedback arrangement can be carried out, for example, by incorporating an electrical current sensor in the induction circuit that senses both too little current (i.e. induction electrical field magnitude needs to be increased) and too much current (i.e., induction electrical field magnitude needs to be decreased).

A controlled liquid feed stock delivery system, including the pump 120, delivers the liquid feed stock 115 at a specified flow rate to the spray nozzle 130. The motor-driven pump 120 is controlled by a controller 145 (e.g., a programmable logic controller) in accordance with a specified set point and a currently sensed flow rate. An operator specifies, for example, a flow rate set point via a human-machine interface (HMI) and then activates the motor-driven pump 120. Thereafter, the controller 145 monitors (via sensor input signals) a flow rate of the liquid feed stock and adjusts (via motor control signals) motor speed of the motor-driven pump 120 to maintain a set/specified flow rate of the liquid feed stock 115 to the spray nozzle 130. In order to maintain a desired flow, the controller 145 continuously receives a measurement signal indicative of an instantaneous flow rate of the liquid feed stock passing through a feed line to the spray nozzle. An in-line flowmeter 150 measures instantaneous flow rate of the liquid feed stock 115 through a pipe section 155 to which the in-line flowmeter 150 is operationally mounted. The in-line flowmeter 150, in turn, provides a signal to the controller 145 that maintains a historical record of sensed flow and provides control over the overall operation of the electrostatic spray drier system 100 (including a speed of the motor-driven pump 130).

Details of the general structure of the electrostatic spray drying system 100, including the controller 145, are well known to those in the industry and thus are not discussed in detail herein. Rather, attention is directed to an exemplary electrical/structural arrangement of spray nozzle including an induction ring mounted proximate an exit aperture thereof for providing an electrostatically charted droplet stream of the liquid feedstock in accordance with illustrative examples of the present disclosure.

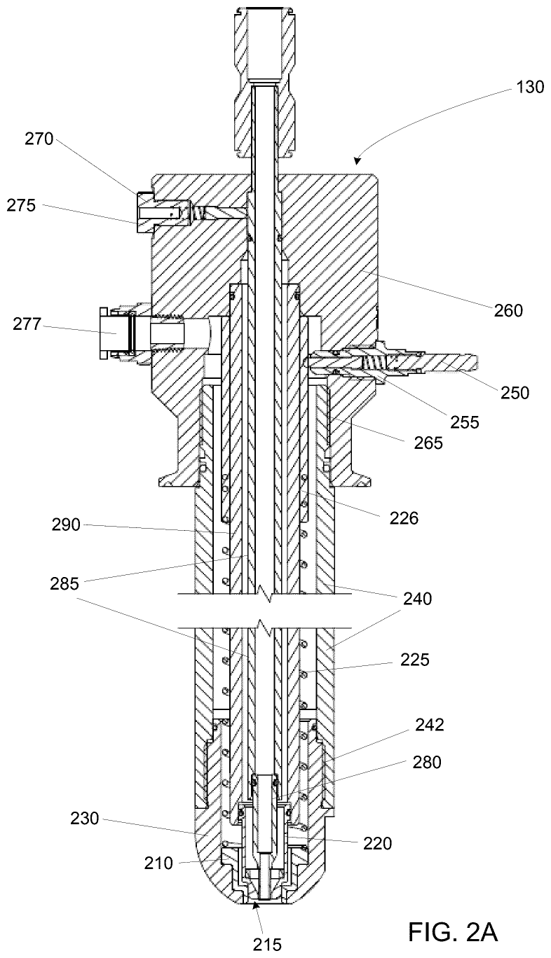

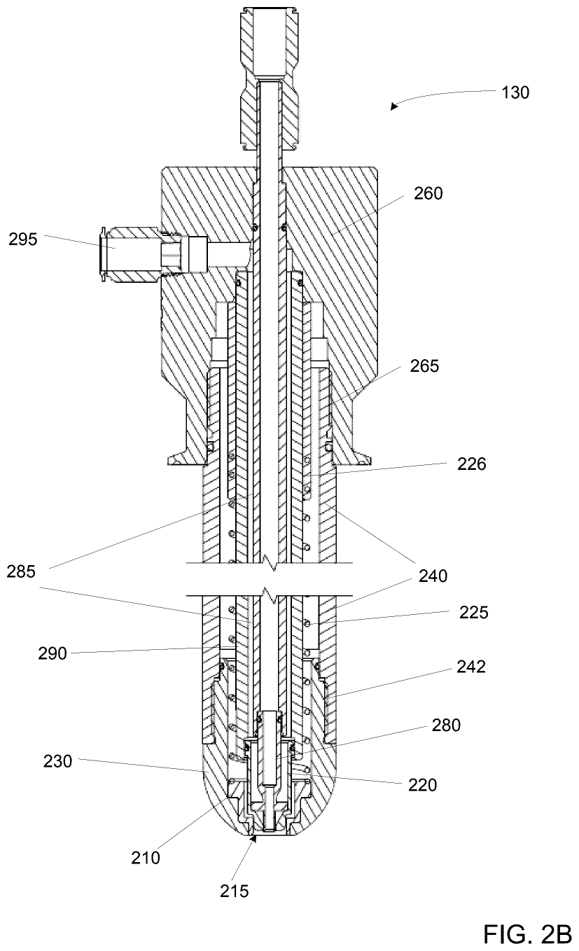

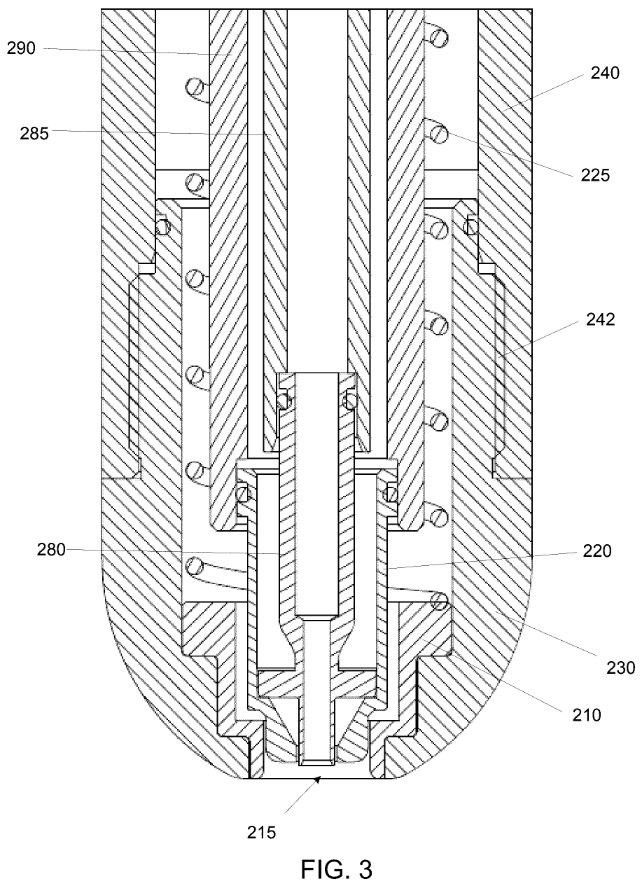

By way of a first specific example, the spray nozzle 130 is a specially configured nozzle assembly that, in operation, exhibits certain electrical properties facilitating generation of a continuous flow of electrostatically charged spray droplets. Turning to FIGS. 2A, 2B and 3, an exemplary electrostatic spray nozzle arrangement is illustratively depicted where electrostatic charging of spray droplets is achieved by an electrical circuit arrangement including an induction ring 210 (corresponding to the induction ring 140 in FIG. 1) that made of an electrically conductive material such as, for example, stainless steel. The induction ring 210 is held in place and protected from outside elements by a nozzle head 230 positioned at an exit aperture of the spray nozzle 130. An opening 215 of the induction ring 210 is sufficiently wide to avoid, with the aid of a purging gas stream, excessive buildup of the liquid feedstock, emitted from an opening of an atomizing gas cap 220, that passes in droplet form through the opening 215. By way of example, the opening 215 has an inner diameter on the order of less than 1 inch for an applied electrical field having a voltage of 500 to 8,000 volts. More particularly, the opening 215 has a diameter of about 0.7 inches. However, in accordance with various spray drying applications, the diameter of the opening 215 and/or the applied voltage (electrical field potential between the induction ring 215 and liquid feedstock exiting the nozzle) are modified in accordance with spray pattern (wide/narrow spray field), and nozzle aperture position (linear displacement along path of spray field) in relation to the opening 215 of the induction ring 210. In the illustrative example, the atomizing gas cap 220 is made of a non-electrically conductive, rigid, and wear-resistant material (e.g., polyetheretherketone (PEEK).

In accordance with an illustrative example, both a purge gas tube 240 and the nozzle head 230 are made of PEEK plastic material or any a suitable relatively rigid, wear-resistant and non-electrically conductive material. The use of non-conductive material inhibits the formation of eddy currents during operation of the induction ring. Moreover, outer surface contours of the nozzle head 230—especially proximate the opening 215—are smooth and convex so as to inhibit accumulation of the sprayed feedstock on the outer surface of the spray nozzle 130.

A first conductive path is provided for generating an electrostatic field at the opening 215 of the induction ring 210 to electrostatically charge droplets of feedstock emitted from the atomizing gas cap. To that end, the induction ring 210 physically abuts and has an electrically conductive contact with an electrically conductive pliable structure, such as for example a spring 225 that is made of a flexible electrically conductive material that is resistant to corrosion (e.g. stainless steel). The spring 225 provides at least part of an electrically conductive path between the induction ring 210 and an induction field (high voltage) electrode 250. In the illustrative example, the electrically conductive path between the induction ring 210 and the induction field electrode 250 further comprises an electrical coupling tube 226 that is configured to physically engage both the spring 225 and the induction field electrode 250 and thus provide an electrically conductive coupling between the spring 225 and electrode 250. The electrical coupling tube 226 is made, for example, of an electrically conductive material such as, for example, stainless steel. Alternatively, an electrically conductive path between the induction ring 210 and the induction field electrode 250 consists solely of the spring 225. In yet another arrangement, an electrically conductive path between the induction ring 210 and the induction field electrode 250 consists solely of the electrical coupling tube 226. However, a hybrid arrangement including both the spring 225 and the electrical coupling tube 226, as a consequence of lateral flexing provided by the spring 225, provides a combination of structural integrity (by the electrical coupling tube 226) and mechanical tolerance and electrically conductive contact assurance (by the spring 225).

In accordance with an illustrative example the nozzle head 230 physically engages a purge gas tube 240. By way of example, the nozzle head 230 and the purge gas tube 240 are physically engaged by complementary screw thread surfaces at 242.

A second conductive path is provided for establishing a complementary electrical (e.g., ground) path from conductive feed lines through which the feedstock passes from the tank 110 (see FIG. 1) to the atomizing gas cap 220. The second conductive path provides a source for inducing a charge (opposite the field potential generated at the opening 215 by the induction ring 210) on the droplets passing from a fluid tip 280, which is made of an electrically conductive material such as, for example stainless steel, providing an electrically grounded conductive surface in contact with the feedstock. The second conductive path continues at a physical and electrical connection between the fluid tip 280 and a fluid tube 285 that is made, for example, of stainless steel and provides a passage for flow of the feedstock to the fluid tip 280.

An atomizing gas tube 290 provides atomizing gas to the atomizing gas cap 220. The atomizing gas tube 290 is, by way of example made of a rigid non-electrically conductive material such as PEEK that is configured to provide a sealed engagement with the atomizing gas cap 220. Alternatively, the atomizing gas tube 290 comprises a conductive material coated with an electrically insulating material. As such, the atomizing gas tube 290 and atomizing gas cap 220 provide an electrically insulating barrier between the first conductive path and the second conductive path described herein above. It is noted that such electrically insulating characteristic may alternatively be achieved by coating exposed surfaces with an insulating coating (e.g., PTFE).

As shown in FIG. 2A, a nozzle body 260 is physically configured with several receptacles/openings for maintaining physical/electrical engagement between components of the spray nozzle 130 illustratively depicted herein. The nozzle body 260 is made, for example, of PEEK plastic material or any a suitable relatively rigid, wear-resistant and non-electrically conductive material. In the illustrative example, the nozzle body 260 includes an induction field electrode receptacle 255 holding the induction field electrode 250 in electrically conductive engagement with the electrically conductive coupling tube 226. The nozzle body 260 includes a ground electrode receptacle 270 holding an electrical ground electrode 275 in electrically conductive engagement with the electrically conductive surface of the fluid tube 285. An induction ring purge gas port 277 provides an opening for feeding a purge gas that flows through the purge gas tube 240 to the opening 215 in the induction ring 210. As further shown in FIG. 2B (a further cross sectional view rotated 90 degrees from the view depicted in FIG. 2A), the nozzle body 260 further includes an atomizing gas port 295 that provides an opening for feeding an atomizing gas to the atomizing gas tube 290.

As shown in FIG. 2A, the nozzle body 260 includes a cylindrical receptacle having a threaded surface at 265 to hold in place the purge gas tube 240 having a complementary threaded outer surface.

Turning to FIG. 3, an additional detailed view is provided of the portion of the spray nozzle depicted in FIGS. 2A and 2B including the nozzle head 230 and the induction ring 210 to enable a clearer view of the various physical relationships depicted in FIGS. 2A and 2B and the corresponding written description provided herein above.

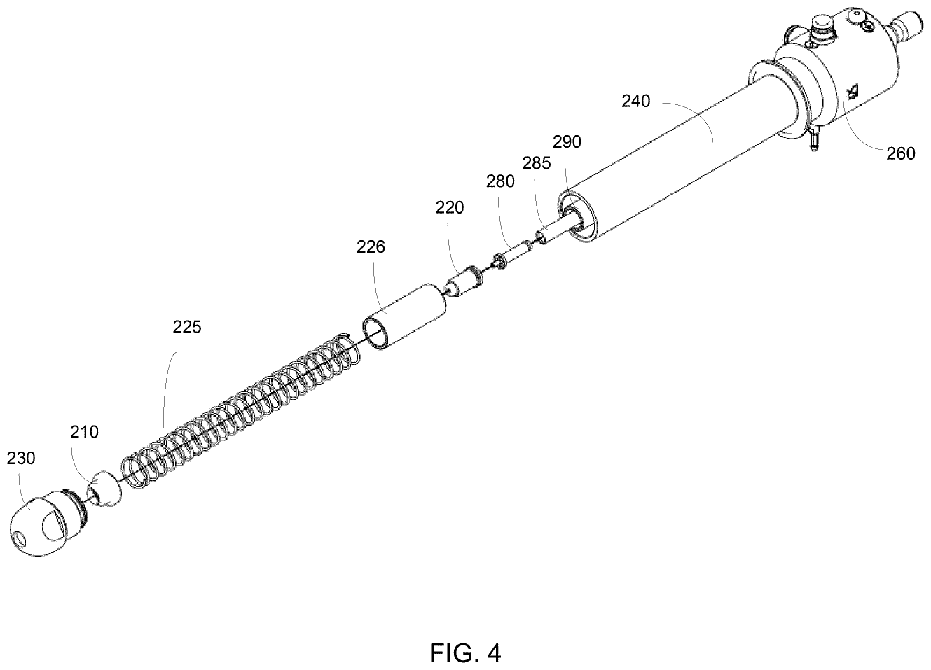

Additionally, FIG. 4 provides an exploded perspective view of the electrostatic spray nozzle assembly depicted in FIGS. 2A and 2B to provide additional visual details of the illustrative example of an electrostatic spray nozzle in accordance with the current disclosure.

Furthermore, while the illustrative examples have been depicted and described with reference to an exemplary electrostatic spray nozzle assembly configurations, the disclosure is not limited to such assemblies. It will be readily appreciated that, in view of the current disclosure, the advantages of the current disclosure are also applicable to a variety of electrostatic spraying systems that include an induction ring. As such, the current disclosure is intended to apply to a wide variety of electrostatic spray nozzle arrangements - with appropriate adjustments to the above-described structures to accommodate variations in particular electrostatic spray applications.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electrostatic spray nozzle assembly comprising:
an induction ring; and
a fluid tip,
wherein the induction ring generates an electrical field for inducing an electrical charge on droplets of a feedstock liquid from the fluid tip that pass through an opening of the induction ring,
wherein the induction ring is electrically coupled to an electrical induction field source via a first conductive path comprising at least an electrically conductive pliable structure,
wherein feedstock flowing through the fluid tip is electrically coupled to a charge carrier source via a second conductive path provided by at least a conductive surface of a fluid tube coupled to the fluid tip, and
wherein the first conductive path and the second conductive path are electrically isolated by an insulating barrier.

2. The electrostatic spray nozzle assembly of claim 1, wherein the electrically conductive pliable structure is a spring structure.

3. The electrostatic spray nozzle assembly of claim 2 wherein the spring structure engages a coupling tube, and wherein the coupling tube electrically conductively couples the spring structure to the electrical induction field source.

4. The electrostatic spray nozzle assembly of claim 1, wherein the induction ring is provided in a nozzle head having a convex outer contour.

5. The electrostatic spray nozzle assembly of claim 4, wherein the nozzle head is made of a non-conducting material.

6. The electrostatic spray nozzle assembly of claim 1, wherein the insulating barrier is provided at least in part by an atomizing gas cap.

7. The electrostatic spray nozzle assembly of claim 6, wherein the insulating barrier is provided at least in part by an atomizing gas tube coupled to the atomizing gas cap.

8. The electrostatic spray nozzle assembly of claim 1, wherein the induction ring has an inner diameter on the order of one inch.

9. The electrostatic spray nozzle assembly of claim 8, wherein the induction ring has an inner diameter of about 0.7 inches.

10. The electrostatic spray nozzle assembly of claim 1 further comprising a purge gas tube to which the nozzle head is connected, wherein the purge gas tube is made of a non-conductive rigid material.

11. An electrostatic spray system including:
an electrostatic spray nozzle assembly comprising:
an induction ring; and
a fluid tip,
wherein the induction ring generates an electrical field for inducing an electrical charge on droplets of a feedstock liquid from the fluid tip that pass through an opening of the induction ring,
wherein the induction ring is electrically coupled to an electrical induction field source via a first conductive path comprising at least an electrically conductive pliable structure;
wherein feedstock flowing through the fluid tip is electrically coupled to a charge carrier source via a second conductive path provided by at least a conductive surface of a fluid tube coupled to the fluid tip,
wherein the first conductive path and the second conductive path are electrically isolated by an insulating barrier; and
a voltage supply for providing an electrical potential to the induction ring via the first conductive path.

12. The electrostatic spray system of claim 11, wherein the electrically conductive pliable structure is a spring structure.

13. The electrostatic spray system of claim 12 wherein the spring structure engages a coupling tube, and wherein the coupling tube electrically conductively couples the spring structure to the electrical induction field source.

14. The electrostatic spray system of claim 11, wherein the induction ring is provided in a nozzle head having a convex outer contour.

15. The electrostatic spray system of claim 14, wherein the nozzle head is made of a non-conducting material.

16. The electrostatic spray system of claim 11, wherein the insulating barrier is provided at least in part by an atomizing gas cap.

17. The electrostatic spray system of claim 16, wherein the insulating barrier is provided at least in part by an atomizing gas tube coupled to the atomizing gas cap.

18. The electrostatic spray system of claim 11, wherein the induction ring has an inner diameter on the order of one inch.

19. The electrostatic spray system of claim 18, wherein the induction ring has an inner diameter of about 0.7 inches.

20. The electrostatic spray system of claim 11 further comprising a purge gas tube to which the nozzle head is connected, wherein the purge gas tube is made of a non-conductive rigid material.

21. The electrostatic spray system of claim 11, wherein the voltage supply is configured to provide the electrical potential at 8,000 volts or less.

22. The electrostatic spray system of claim 11, further comprising:
a sensor providing a feedback signal indicative of operation of the electrostatic spray system, and
a controller operating on the feedback signal to adjust the electrical potential.

23. The electrostatic spray system of claim 22, wherein the feedback signal is indicative of electrical current.
